(19) United States
(12) Patent Application Publication
(10) Pub. No.: US 2007/0012075 A1
(43) Pub. Date: Jan. 18, 2007

(54) BRIEFCASE HAVING COMBINATION LOCK

(76) Inventor: JIE XIAO, ISSAQUAH, WA (US)

Correspondence Address: NONGQIANG FAN, PO BOX 377, ISSAQUAH, WA, 98027, US

(21) Appl. No.: 11/161,741

(22) Filed: Aug. 15, 2005

Related U.S. Application Data
(60) Provisional application No. 60/700,236, filed on Jul. 18, 2005.

(51) Int. Cl. E05B 65/52; A45C 13/10

(52) U.S. Cl. 70/69

(57) ABSTRACT

A briefcase includes at least one combination lock. The combination lock includes a group of at least three tumbler rings. Each tumbler ring is operable to rotate and to settle at one of multiple predetermined positions. Each tumbler ring has multiple labels thereon and each of the multiple labels corresponds to one of the multiple predetermined positions. In the combination lock, each tumbler ring has thereon a wild-card position-label and multiple alphabetical-letter position-labels. Each of the multiple alphabetical-letter position-labels is a single alphabetical-letter. The wild-card position-label is configured for representing any alphabetical-letters.

### RELATED APPLICATIONS

This application claims the benefit of U.S. Provisional Application No. 60/700,236, filed on Jul. 18, 2005, and titled “Briefcase having combination lock.”

### BACKGROUND

The present invention relates generally to briefcases having combination locks.

A briefcase generally can include one or more combination locks. While most of combination locks use number labels to indicate positions of each tumbler ring on the lock, it is recognized that combination locks using letter labels may have some advantages that are absent in combination locks using number labels. For example, a combination lock using letter labels can use a word rather than a string of numbers to represent the “password” combination for opening the lock. Ideally, if each tumbler ring on a lock has twenty-six positions and each position is labeled with one of the twenty-six alphabetical letters, then, any desired word (with number of letters not more than the number of the tumbler rings) can be used as the “password” combination for opening the lock. In reality, however, many combination locks have tumbler rings each have fewer than twenty-six positions (e.g., only ten positions).

When a combination lock have tumbler rings each have fewer than twenty-six positions, a subset of twenty-six letters are used to indicated the positions of each tumbler ring on the lock. For example, if each tumbler ring has only ten positions, then, a set of ten letters can be used to indicate the positions of each tumbler ring. With only ten letters for each tumbler ring, not all desired words can be selected as the “password” combination for opening the lock.

In this application, applicant describes a new method for making combination locks. With a combination lock as described therein, a large number of words can be spelled on the combination lock. Such kinds of combination lock can be installed in briefcases.

### SUMMARY

In one aspect, this application is directed to a briefcase that includes at least one combination lock. The combination lock includes a group of at least three tumbler rings. Each tumbler ring is operable to rotate and to settle at one of multiple predetermined positions. Each tumbler ring has multiple labels thereon and each of the multiple labels corresponds to one of the multiple predetermined positions. In the combination lock, each tumbler ring has thereon a wild-card position-label and multiple alphabetical-letter position-labels. Each of the multiple alphabetical-letter position-labels is a single alphabetical-letter. The wild-card position-label is configured for representing any alphabetical-letters.

In specific implementations, the group of at least three tumbler rings can be configured to rotate around an axis. Each tumbler ring can have thereon multiple position-labels consisting of a wild-card position-label and multiple alphabetical-letter position-labels. A wild-card position-label can include a star position-label (“*’), a dollar sign position-label (“$’), a logo position-label, or a blank position-label. The group of at least three tumbler rings can be a group of four tumbler rings. The group of at least three tumbler rings can be a group of five tumbler rings.

In another aspect, this application is directed to a method of configuring a briefcase that includes at least one combination lock. The at least one combination lock has a plurality of tumbler rings. Each tumbler ring has a plurality of position-labels. Each position-label on a given tumbler ring indicates one of the multiple predetermined positions that the given tumbler ring is configured to settle at. The method includes selecting one wild-card position-label and multiple alphabetical-letter position-labels for each tumbler ring of the combination lock on the briefcase. Here, each of the multiple alphabetical-letter position-labels is a single alphabetical-letter. The one wild-card position-label is selected for representing any alphabetical-letters.

As specific implementations, the method can include selecting any one of a star (“*”), a dollar sign (“$”), a blank, and a logo as a wild-card position-label for each tumbler ring of the at least one combination lock on the briefcase. The method can include selecting randomly a subset of alphabetical-letters from the twenty-six alphabetical-letters as the multiple alphabetical-letter position-labels for each tumbler ring of the at least one combination lock on the briefcase. The method can include selecting a subset of alphabetical-letters from the twenty-six alphabetical-letters based on a design algorithm as the multiple alphabetical-letter position-labels for each tumbler ring of the at least one combination lock on the briefcase.

In one implementation, the design algorithm can include finding a list of most frequently used letters regardless where a letter is used in a word based on a selection of a group of words. The design algorithm can also include selecting a subset of alphabetical-letters from the list of most frequently used letters.

In another aspect, this application is directed to a briefcase that includes at least one combination lock. The combination lock includes a group of at least three tumbler rings configured to rotate around an axis. Each tumbler ring has multiple position-labels thereon and is operable to be set at a settled position selected from multiple predetermined positions. Each one of the multiple position-labels corresponds to one of the multiple predetermined positions. In the combination lock, the multiple position-labels include a wild-card position-label and multiple alphabetical-letter position-labels. Each of the multiple alphabetical-letter position-labels is a single alphabetical-letter. The wild-card position-label is configured for representing any alphabetical-letters.

As specific implementations, the multiple position-labels can consist of a wild-card position-label and multiple alphabetical-letter position-labels each being a single alphabetical-letter. In one implementation, the briefcase includes two combination locks. Each of the two combination locks includes a group of at least three tumbler rings configured to rotate around an axis. Each tumbler ring has multiple position-labels thereon and is operable to be set at a settled position selected from multiple predetermined positions. Each one of the multiple position-labels corresponds to one of the multiple predetermined positions. In each combination lock, the multiple position-labels include a wild-card position-label and multiple alphabetical-letter position-labels. Each of the multiple alphabetical-letter position-labels is a single alphabetical-letter. The wild-card position-label is configured for representing any alphabetical-letters.

### BRIEF DESCRIPTION OF THE DRAWINGS

The present invention will be understood more fully from the detailed description and accompanying drawings of the invention set forth herein. However, the drawings are not to be construed as limiting the invention to the specific embodiments shown and described herein. Like reference numbers are designated in the various drawings to indicate like elements.

FIG. 1A and FIG. 1B illustrate a combination lock having four tumbler rings that have wild-card position-labels.

FIG. 2 is an example of a table illustrating each of the four tumbler rings has ten positions in which each of nine positions is labeled with an alphabetical-letter and one position is labeled with a wild-card.

FIG. 3 is an example of a table illustrating each of the four tumbler rings has ten positions in which each of ten positions is labeled with an alphabetical-letter.

FIG. 4 is another example of a table illustrating each of the four tumbler rings has ten positions in which each of nine positions is labeled with an alphabetical-letter and one position is labeled with a wild-card.

FIG. 5 is an example of a briefcase that includes two combination locks.

### DETAILED DESCRIPTION

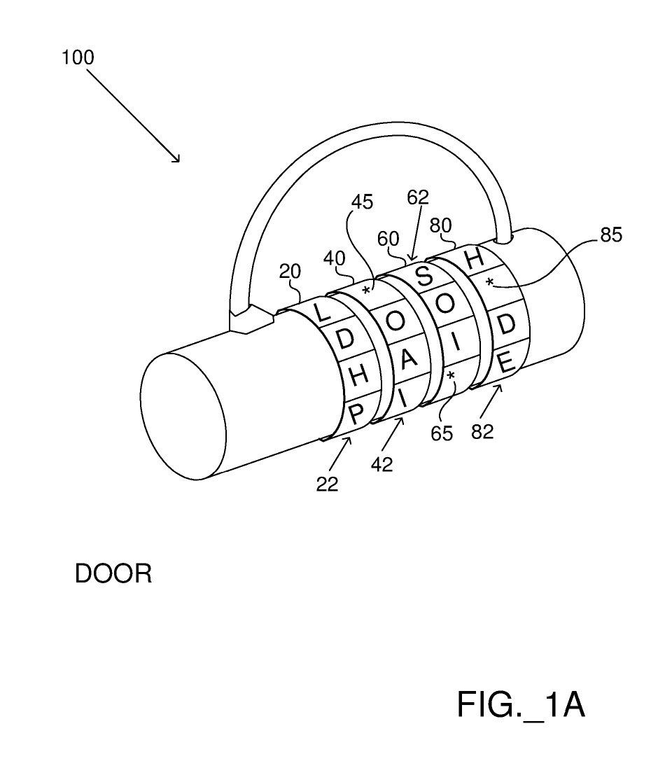

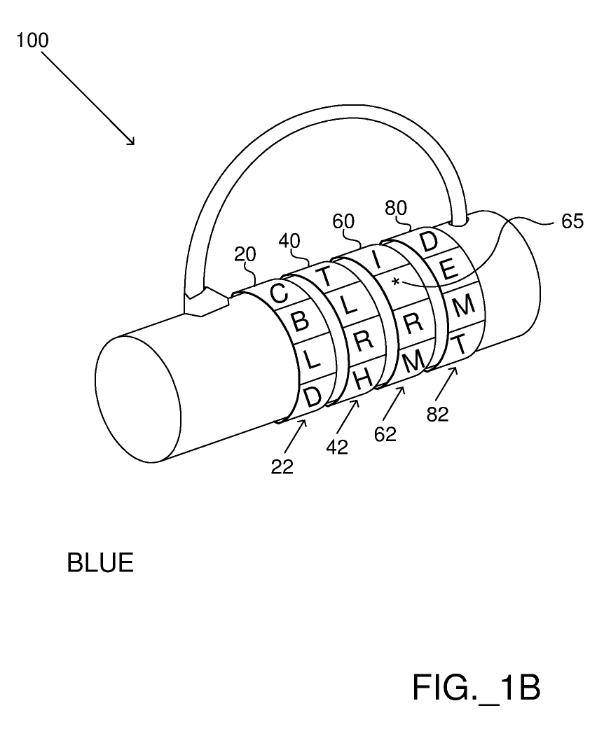

FIG. 1A and FIG. 1B illustrate a combination lock 100 having four tumbler rings (20, 40, 60, and 80) that have wild-card position-labels (e.g., 45, 65, or 85). In the figures, each tumbler ring (20, 40, 60, or 80) can rotate around an axis. Each tumbler ring (20, 40, 60, or 80) can be settled at one of multiple predetermined positions. In one implementation, each tumbler ring can be settled at one of ten possible positions. On each tumbler ring, there are multiple position-labels. Each of the multiple position-labels indicates one of the multiple positions that a tumbler ring can settle at. For example, when a tumbler ring can be settled at one of ten predetermined positions, the tumbler ring can be marked with ten position-labels and each of the ten position-labels indicates one of the one of ten predetermined positions.

In FIG. 1A and FIG. 1B, each tumbler ring has a wild-card position-label (e.g., 45, 65, or 85) and multiple alphabetical-letter position-labels (e.g., 22, 42, 62, or 82). Each of the multiple alphabetical-letter position-labels is a single alphabetical-letter. The wild-card position-label can be a star “*”, dollar sign “$”, a company log, or simply a blank. Other selections of the wild-card position-label are also possible.

In one implementation, when each tumbler ring can be settled at one of ten possible positions, each tumbler ring can have one wild-card position-label and nine alphabetical-letter position-labels. The nine alphabetical-letter position-labels can be randomly selected from the twenty-six alphabetical-letters. The nine alphabetical-letter position-labels can be selected from the twenty-six alphabetical-letters based on certain design algorithm.

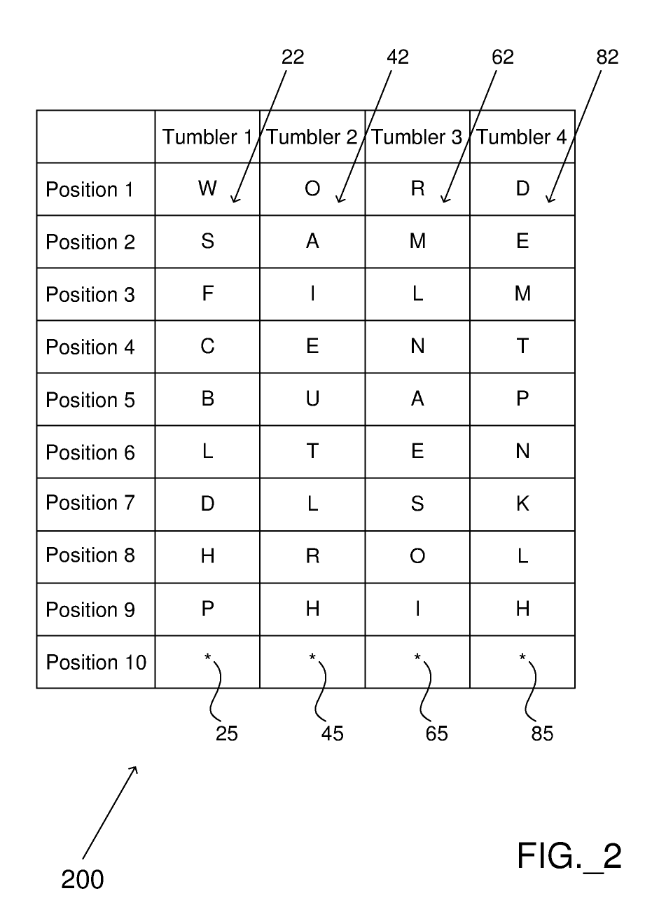

As one particular example, FIG. 2 is an example of a table illustrating each of the four tumbler rings has ten positions in which each of nine positions is labeled with an alphabetical-letter and one position is labeled with a wild-card. In FIG. 2, tumbler 1 has one wild-card position-label 25 in the form of a star “*” and nine alphabetical-letters 22 consisting of W, S, F, C, B, L, D, H, and P; the wild-card card “*” can represent any of the twenty-six alphabetical-letters that are not listed on Tumbler 1. Tumbler 2 has one wild-card position-label 45 in the form of a star “*” and nine alphabetical-letters 42 consisting of O, A, I, E, U, T, L, R, and H; the wild-card card “*” can represent any of the twenty-six alphabetical-letters that are not listed on Tumbler 2. Tumbler 3 has one wild-card position-label 65 in the form of a star “*” and nine alphabetical-letters 62 consisting of R, M, L, N, A, E, S, O, and I; the wild-card card “*” can represent any of the twenty-six alphabetical-letters that are not listed on Tumbler 3. Tumbler 4 has one wild-card position-label 85 in the form of a star “*” and nine alphabetical-letters 82 consisting of D, E, M, T, P, N, K, L, and H; the wild-card card “*” can represent any of the twenty-six alphabetical-letters that are not listed on Tumbler 4.

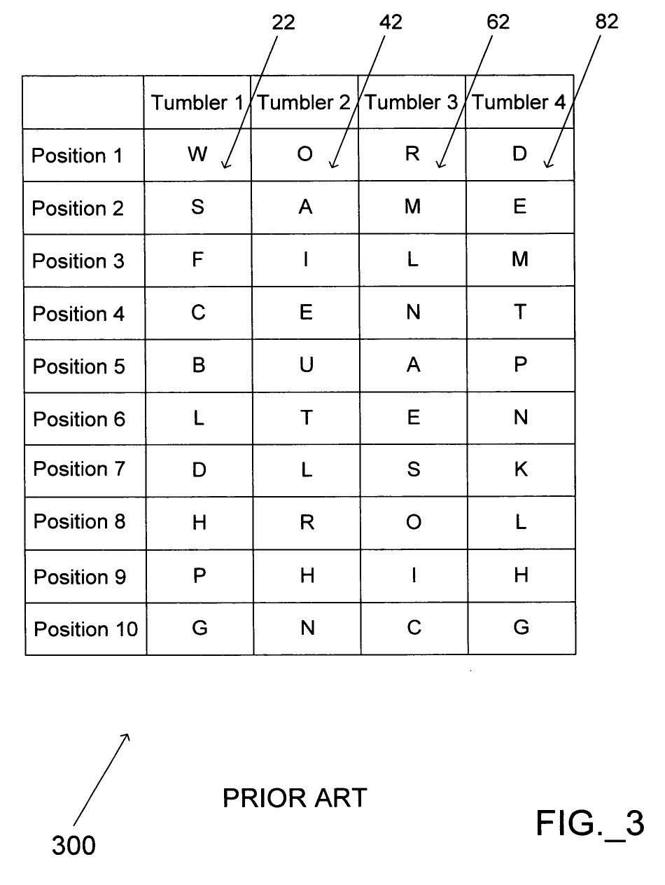

The result of selecting alphabetical-letter position-labels as show in a table 200 in FIG. 2 is obtained by modifying a result of selecting alphabetical-letter position-labels as shown in FIG. 3. The table 300 in FIG. 3 is related to a method as described in U.S. Pat. No. 6,621,405 (see, for example, FIG. 2 of U.S. Pat. No. 6,621,405). After replacing the tenth favorable alphabetical-letter for each tumbler ring with a wild-card position-label in the form of a star “*”, one can convert table 300 in FIG. 3 into table 200 in FIG. 2. More specifically, the tenth favorable alphabetical-letter for Tumbler 1, G, is replaces with a star “*”; the tenth favorable alphabetical-letter for Tumbler 2, N, is replaces with a star “*”; the tenth favorable alphabetical-letter for Tumbler 3, C, is replaces with a star “*”; and the tenth favorable alphabetical-letter for Tumbler 4, G, is replaces with a star “*”.

The result as show in FIG. 2 has several advantages over the result as show in FIG. 3. First, some words that cannot be spelled with the result in FIG. 3 can now be spelled with the result in FIG. 2. As specific examples, using the result of FIG. 2, one can spell “BLUE” as “BL*E”, spell “DOOR” as “DOO*”, and “HERO” as “HER*”; in contrast, none of these words (BLUE, DOOR, or HERO) can be spelled using the result in FIG. 3. Therefore, such feasibility of using a wild-card to represent letters that are not expressly listed on tumbler rings can be quite useful. Second, words with number of letters less than the number of tumbler rings can now be spelled. More specifically, three-letters words can be spelled even a lock has four tumbler rings. As an example, using the result of FIG. 2, one can spell “CAR” as “”CAR*”, “SUN” as “SUN*”, “TOP” as “*TOP”; such feasibility is particular useful when large number of tumbler rings (e.g., six tumbler rings) are used in a combination lock. In addition, the result of FIG. 2 can be used to spell large number of foreign words, and the result of FIG. 2 can also be used to spell some special words that are not listed in dictionaries but that have particular meanings to a user.

In one implementation, when each of the four tumbler rings has a wild-card position-label, any four-letter words can be theoretically spelled, because the wild-card can theoretically represent any of the twenty-six letters. In a trivial example, “B***” can represent any four-letter words starting with a first letter “B”; in practice, however, a user may want to use “BL*E” to represent “BLUE” rather than using “B***” to represent “BLUE.”

In an implementation of combination lock as shown in FIG. 1A and FIG. 1B, four tumbler rings are used. In other implementations, three or five tumbler rings can be used. Still in other implementations, more than five tumbler rings can be used.

In some implementations, the multiple alphabetical-letter position-labels can be selected from the twenty-six alphabetical-letters based on a design algorithm that is somewhat related to the method as described in U.S. Pat. No. 6,621,405. In some other implementations, multiple alphabetical-letter position-labels can also be selected based on a design algorithm that is not so much related to the method as described in U.S. Pat. No. 6,621,405. Still in other implementations, the multiple alphabetical-letter position-labels can be randomly selected from the twenty-six alphabetical-letters.

In one implementation, when each of the four tumbler rings has ten possible positions, an example design algorithm can include two steps. In the first step, ten most favorable letters for each of the four tumbler rings can be selected using a method related the method as described in U.S. Pat. No. 6,621,405. In the second step, only the top nine most favorable letters are retained; the tenth most favorable letter is discarded and is replaced with a wild card, such as a star (“*”), a dollar sign (“$”), a logo, or simply a blank.

In another implementation, when each of the four tumbler rings has ten possible positions, an example design algorithm can include two steps. In the first step, nine most favorable letters for each of the four tumbler rings can be selected using a method related the method as described in U.S. Pat. No. 6,621,405. In the second step, a wild card is used as the tenth most favorable letter to form a total of ten position-labels along with the other nine most favorable letters.

In another implementation, when each of the four tumbler rings has ten possible positions, an example design algorithm can include four independent steps. In the first independent step, the most frequently used letters that can be used as the first letter of a word are selected; these top nine most-frequently-used letters and a wild card are used for the ten position-labels for the first tumbler rings. In the second independent step, the most frequently used letters that can be used as the second letter of a word are selected; these top nine most-frequently-used letters and a wild card are used for the ten position-labels for the second tumbler rings. In the third independent step, the most frequently used letters that can be used as the third letter of a word are selected; these top nine most-frequently-used letters and a wild card are used for the ten position-labels for the third tumbler rings. In the fourth independent step, the most frequently used letters that can be used as the fourth letter of a word are selected; these top nine most-frequently-used letters and a wild card are used for the ten position-labels for the fourth tumbler rings.

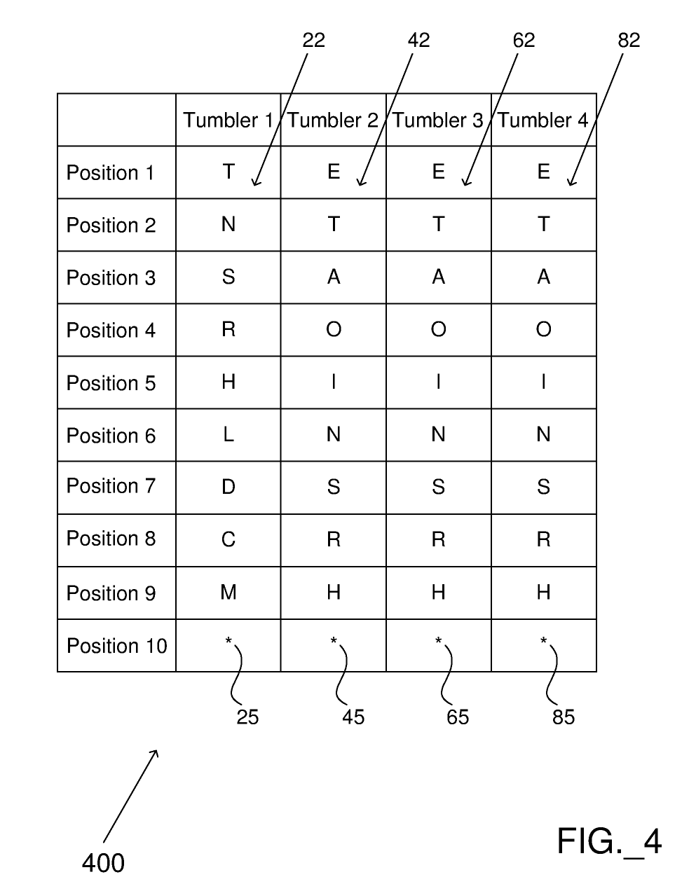

In still another implementation, when each of the four tumbler rings has ten possible positions, an example design algorithm can include two independent steps. Both of the two independent steps depend on a study on what is the most frequently used letters in a group of words. Different studies based on different selections of the group of words (e.g., in Webster dictionary, in press, or in literature) may yield different lists of most frequently used letters. In one specific example, a study found that most frequently used letters follows the following list: “etaoinsrhldcumfpgwybvkxjqz.” Based on this list of most frequently used letters, in the first independent step, the top fourteen most-frequently-used letters are selected and the five vowels are discarded; the resulted nine letters, “tnsrhldcm,” are selected as the alphabetical-letter position-labels for the first tumbler ring. In the second independent step, the top nine most-frequently-used letters, “etaoinsrh,” are selected as the alphabetical-letter position-labels for each of the second, third, and fourth tumbler rings. FIG. 4 shows a table 400 that lists the position-labels for each of the four tumbler rings based on the design algorithm as described above. In table 400 as shown in FIG. 4, each of the four tumbler rings has ten positions in which each of nine positions is labeled with an alphabetical-letter and one position is labeled with a wild-card.

Based on above teachings, people skilled in the art can use other design algorithms to select multiple alphabetical-letters, and subsequently, use a wild-card along with the selected multiple alphabetical-letters as the position-labels for each of the tumbler rings.

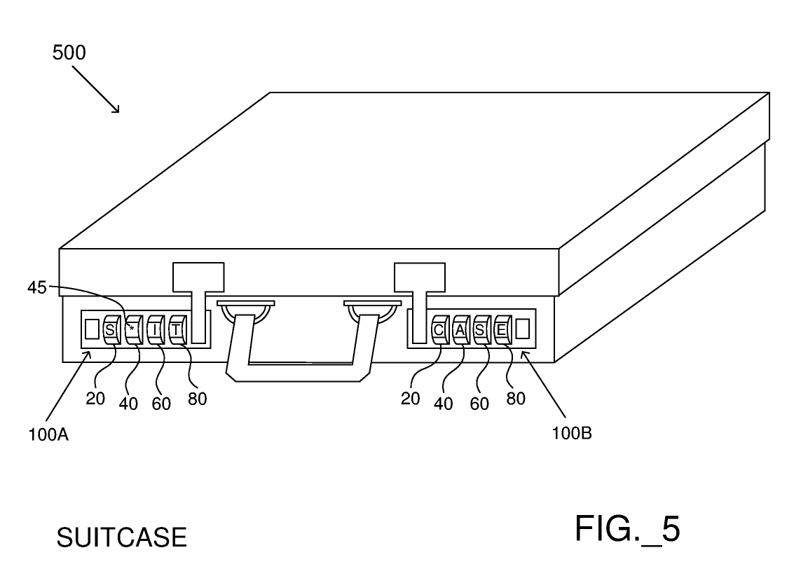

FIG. 5 shows an example of a briefcase 500 that includes two combination locks 100A and 100B. Each of the two combination locks (100A, or 100B) includes four tumbler rings, 20, 40, 60, and 80. Each tumbler ring (20, 40, 60, or 80) can be settled at one of multiple predetermined positions. On each tumbler ring, there are multiple position-labels. Each of the multiple position-labels indicates one of the multiple positions that a tumbler ring can settle at. Each tumbler ring has a wild-card position-label (e.g., 45) and multiple alphabetical-letter position-labels. Each of the multiple alphabetical-letter position-labels is a single alphabetical-letter. The wild-card position-label can be a star “*”, dollar sign “$”, a company log, or simply a blank. Other selections of the wild-card position-label are also possible.

In FIG. 5, when each of the two combination locks (100A, or 100B) includes four tumbler rings, large number of eight-letters words can be spelled. For example, assume that the position-labels for the four tumbler rings on each combination lock (100A, or 100B) are selected based on table 400 on FIG. 4, then, “SUITCASE” can be spelled as “S*ITCASE”; where the wild-card “*” is used to represent letter “U” that can not be found on tumbler ring 40 in combination lock 100A.

In the implementation as shown in FIG. 5, briefcase 500 includes two combination locks. In other implementations, briefcase 500 can include one combination lock. Still in other implementations, 500 can include more than two combination locks.

The present invention has been described in terms of a number of implementations. The invention, however, is not limited to the implementations depicted and described. Rather, the scope of the invention is defined by the appended claims.

1. A briefcase comprising a combination lock, wherein a combination lock comprises:
a group of at least three tumbler rings, each tumbler ring operable to rotate and to settle at one of multiple predetermined positions and having multiple position-labels thereon each corresponding to one of the multiple predetermined positions, and wherein each tumbler ring has thereon only one wild-card position-label and multiple alphabetical-letter position-labels each being a single English alphabetical-letter, and the wild-card position-label is different from any one of the twenty-six English alphabetical-letters and is configured for representing any one of the twenty-six English alphabetical-letters.

2. The briefcase of claim 1, wherein the group of at least three tumbler rings is configured to rotate around an axis.

3. (canceled)

4. The briefcase of claim 1, wherein a wild-card position-label includes a star position-label (“*’).

5. The briefcase of claim 1, wherein a wild-card position-label includes a dollar sign position-label (“$’).

6. The briefcase of claim 1, wherein a wild-card position-label includes a blank position-label.

7. The briefcase of claim 1, wherein a wild-card position-label includes a logo position-label.

8. The briefcase of claim 1, wherein a group of at least three tumbler rings comprises:
a group of four tumbler rings.

9. The briefcase of claim 1, wherein a group of at least three tumbler rings comprises:
a group of five tumbler rings.

10. A method of configuring a combination lock that includes a plurality of tumbler rings each having a plurality of position-labels, each position-label on a given tumbler ring on the at least one combination lock indicating one of the multiple predetermined positions that the given tumbler ring is configured to settle at, the method comprises:
selecting one wild-card position-label and multiple alphabetical-letter position-labels for each tumbler ring of the combination lock, each of the multiple alphabetical-letter position-labels being a single English alphabetical-letter, wherein the one wild-card position-label is different from any one of the twenty-six English alphabetical-letters and is selected for representing any one of the twenty-six English alphabetical-letters.

11. The method of claim 10, comprises:
selecting any one of a star (“*”), a dollar sign (“$”), a blank, and a logo as a wild-card position-label for each tumbler ring of the combination lock.

12. The method of claim 10, comprises:
selecting randomly a subset of English alphabetical-letters from the twenty-six English alphabetical-letters as the multiple alphabetical-letter position-labels for each tumbler ring of the combination lock.

13. The method of claim 10, comprises:
selecting a subset of English alphabetical-letters from the twenty-six English alphabetical-letters based on a design algorithm as the multiple alphabetical-letter position-labels for each tumbler ring of the combination lock.

14. The method of claim 13, wherein the design algorithm comprises:
finding a list of most frequently used letters regardless where a letter is used in a word based on a selection of a group of words; and
selecting a subset of English alphabetical-letters from the list of most frequently used letters.

15. A briefcase comprising a combination lock, wherein a combination lock comprises:
a group of at least three tumbler rings configured to rotate around an axis, each tumbler ring having multiple position-labels thereon and operable to be set at a settled position selected from multiple predetermined positions, each one of the multiple position-labels corresponding to one of the multiple predetermined positions, and wherein the multiple position-labels comprises only one wild-card position-label and multiple alphabetical-letter position-labels each being a single English alphabetical-letter, and the wild-card position-label is different from any one of the twenty-six English alphabetical-letters and is configured for representing any one of the twenty-six English alphabetical-letters.

16. The briefcase of claim 15, wherein the multiple position-labels consists of a wild-card position-label and multiple alphabetical-letter position-labels each being a single English alphabetical-letter.

17. The briefcase of claim 15, comprising two combination locks wherein each of the two combination locks comprises:
a group of at least three tumbler rings configured to rotate around an axis, each tumbler ring having multiple position-labels thereon and operable to be set at a settled position selected from multiple predetermined positions, each one of the multiple position-labels corresponding to one of the multiple predetermined positions, and wherein the multiple position-labels comprises only one wild-card position-label and multiple alphabetical-letter position-labels each being a single English alphabetical-letter, and the wild-card position-label is different from any one of the twenty-six English alphabetical-letters and is configured for representing any one of the twenty-six English alphabetical-letters.

18. A combination lock comprises:
a group of at least three tumbler rings, each tumbler ring operable to rotate and to settle at one of multiple predetermined positions and having multiple position-labels thereon each corresponding to one of the multiple predetermined positions, and wherein each tumbler ring has thereon only one wild-card position-label and multiple alphabetical-letter position-labels each being a single English alphabetical-letter, and the wild-card position-label is different from any one of the twenty-six English alphabetical-letters and is configured for representing any one of the twenty-six English alphabetical-letters.
